(19) United States
(12) Patent Application Publication
(10) Pub. No.: US 2018/0345469 A1
(43) Pub. Date: Dec. 6, 2018

(54) RECIPROCATING WORK MACHINE

(71) Applicant: HITACHI KOKI CO., LTD., Tokyo (JP)

(72) Inventors: Daijiro TANABE, Ibaraki (JP); Goya FUJIMOTO, Ibaraki (JP)

(21) Appl. No.: 15/779,486

(22) PCT Filed: Oct. 28, 2016
(86) PCT No.: PCT/JP2016/082059

§ 371 Date: May 25, 2018

(30) Foreign Application Priority Data
Nov. 26, 2015 (JP) 2015-230281
Aug. 30, 2016 (JP) 2016-168064

(51) Int. Cl. B25D 17/04; B25D 17/24

(52) U.S. Cl. CPC B25D 17/043; B25D 2250/371; B25D 2217/0073; B25D 17/24

(57) ABSTRACT

Provided is a reciprocating work machine capable of further reducing vibration transmitted from a housing to a handle. The reciprocating work machine provided with an electric motor, a piston and a striker reciprocating by power of the electric motor and striking a tool, and a housing accommodating the electric motor, the piston, and the striker, includes: a resin handle operably connected to the housing; a spring provided between the housing and the handle and expanding and contracting in a reciprocating direction of the piston and the striker when the handle operates relative to the housing; and a weight provided to the handle and made of a material having a specific gravity higher than each of a specific gravity of a material constituting the handle and a specific gravity of a material constituting the housing.

### TECHNICAL FIELD

The present invention relates to a reciprocating work machine having a striking mechanism that reciprocates.

### BACKGROUND ART

A reciprocating work machine having a striking mechanism that reciprocates is described in Patent Document 1. The reciprocating work machine according to Patent Document 1 includes a housing accommodating a motor, a motion conversion mechanism converting a rotational force of the motor into a reciprocating force, a handle connected to the housing, a cylinder provided inside the housing, a piston reciprocating inside the cylinder, a striker movably disposed inside the cylinder, an air chamber formed between the striker and the piston inside the cylinder, and an intermediate element supported by the housing and transmitting a striking force of the striker to a tool.

A first end portion of the handle is connected to the housing via elastic means, and a second end portion of the handle is rotatably connected to the housing via a supporting shaft. In the reciprocating work machine according to Patent Document 1, the piston reciprocates, and the striker strikes the tool. Due to a reaction force upon striking, the housing vibrates in a reciprocating direction of the piston. The elastic means reduces vibration transmitted from the housing to the handle.

### RELATED ART DOCUMENTS

### Patent Documents

Patent Document 1: Japanese Patent No. 4626574

### SUMMARY OF THE INVENTION

### Problems to be Solved by the Invention

The reciprocating work machine according to Patent Document 1 is not capable of sufficiently reducing the vibration transmitted from the housing to the handle, and a further reduction of the vibration of the handle has been desired.

It is an object of the present invention to provide a reciprocating work machine with good workability by further reducing vibration of a handle.

### Means for Solving the Problems

A reciprocating work machine according to one embodiment is provided with a motor, a striking mechanism reciprocating by power of the motor and striking a tool, and a housing accommodating the motor and the striking mechanism, and the reciprocating work machine includes a resin handle operably connected to the housing, an elastic body provided between the housing and the handle and expanding and contracting in a reciprocating direction of the striking mechanism when the handle is operated relative to the housing, and a weight provided to the handle and made of a material having a specific gravity higher than each of a specific gravity of a material constituting the handle and a specific gravity of a material constituting the housing.

### Effects of the Invention

According to the reciprocating work machine, vibration of the handle can be more reduced, and workability is improved.

### BRIEF DESCRIPTIONS OF THE DRAWINGS

FIG. 1 is a front view of a reciprocating work machine;

FIG. 2 is a partial cross-sectional view of the reciprocating work machine in a plan view;

FIG. 3 is a cross-sectional view of a striking case of the reciprocating work machine in a front view;

FIG. 4 is a cross-sectional view of a motor case and a gear case of the reciprocating work machine in a front view;

FIG. 5 is a cross-sectional view of a handle of the reciprocating work machine in a front view;

FIG. 6 is a cross-sectional view of the handle of the reciprocating work machine in a front view;

FIG. 7 is a partial cross-sectional view of a vibration reduction mechanism of the reciprocating work machine in a plan view;

FIG. 8 is a partial cross-sectional view of the vibration reduction mechanism of the reciprocating work machine in a plan view;

FIG. 9 is a block diagram of a control system of the reciprocating work machine;

FIG. 10 is a graph indicating characteristics of the reciprocating work machine according to an embodiment;

FIG. 11 is a graph indicating characteristics of a reciprocating work machine according to a comparative example;

FIG. 12 is a graph indicating characteristics of a reciprocating work machine according to another comparative example;

FIG. 13 is a cross-sectional view of another example of the handle of the reciprocating work machine in a front view;

FIG. 14 is a cross-sectional view illustrating a state in which the handle and a housing are moved closer to each other from FIG. 13;

FIG. 15 is a partial cross-sectional view of another example of the vibration reduction mechanism of the reciprocating work machine in a plan view;

FIG. 16 is a cross-sectional view illustrating a state in which the handle and the housing are moved closer to each other from FIG. 15; and

FIG. 17 is a cross-sectional view of the vibration reduction mechanism of the reciprocating work machine taken along a D-D surface of FIG. 15.

### DETAILED DESCRIPTION OF PREFERRED EMBODIMENTS

Hereinafter, embodiments of the reciprocating work machine will be described with reference to the drawings.

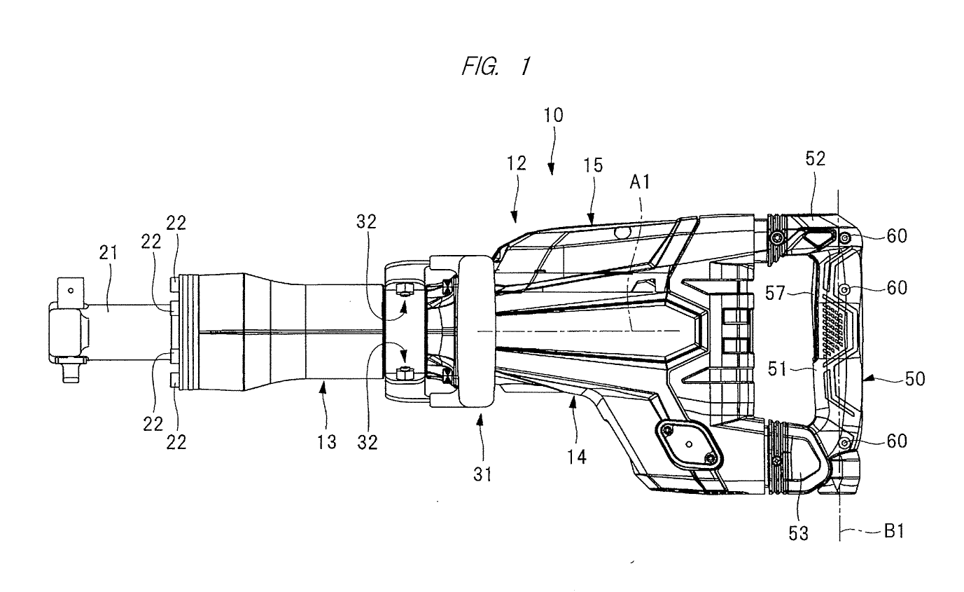

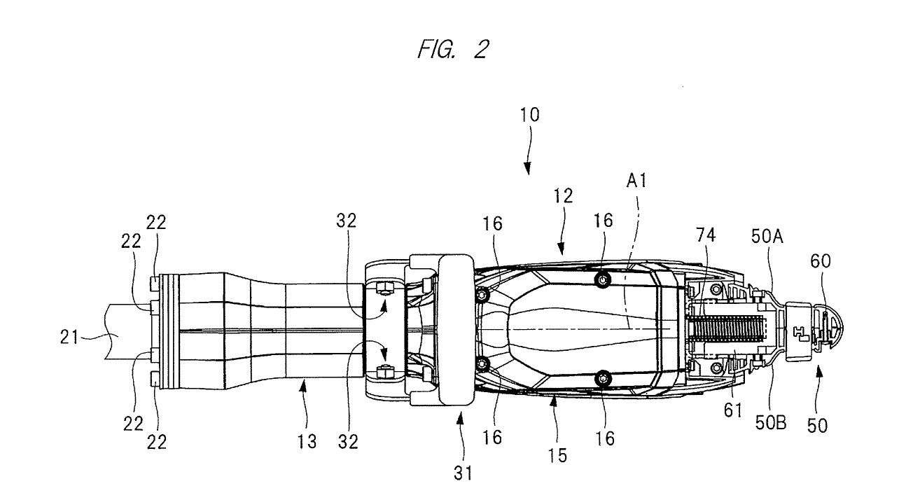

A reciprocating work machine 10 illustrated in FIGS. 1 and 2 is also referred to as a hammer drill, and the reciprocating work machine 10 strikes a tool 11. The reciprocating work machine 10 is used in drilling operation of an object, chipping operation of an object, and crushing operation of the object. The object includes concrete and stone materials.

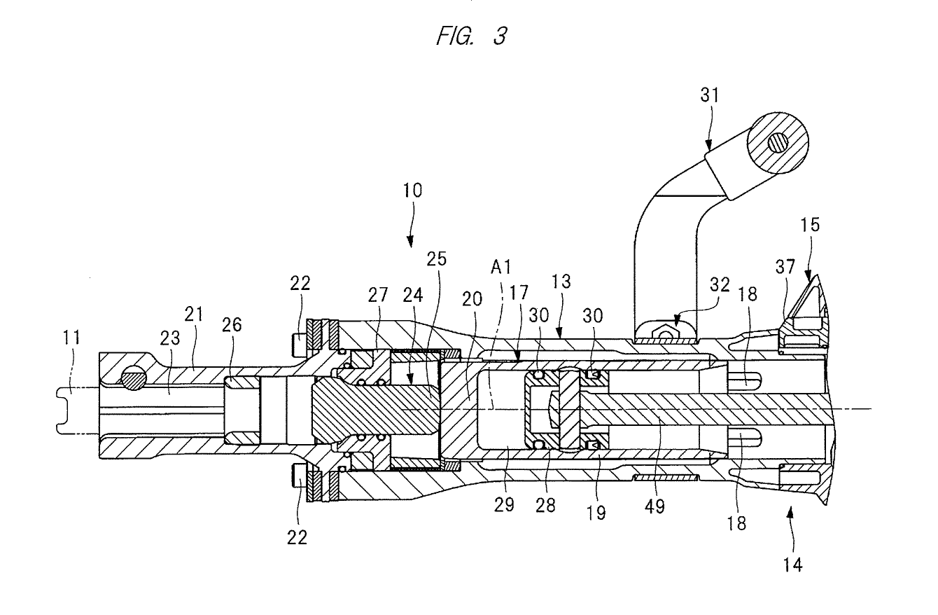

The reciprocating work machine 10 includes a housing 12, and the housing 12 is configured such that a striking case 13, a motor case 14, and a gear case 15 are fixed together with a screw member 16. Also, a handle 50 is connected to the housing 12. The striking case 13 is cylindrical as in FIG. 3, and a striker 17 is provided inside the striking case 13. The striking case 13 is provided with a guide portion 18, and the striker 17 is operable in a direction of an axis line A1 along the guide portion 18. The striker 17 includes a cylindrical portion 19, and a bottom portion 20 continuous to a first end portion of the cylindrical portion 19 in the direction of the axis line A1. A second end portion of the cylindrical portion 19 in the direction of the axis line A1 is open.

A holder 21 is provided outside the striking case 13, and the holder 21 is fixed to a first end portion of the striking case 13 in the direction of the axis line A1 with a screw member 22. The holder 21 is cylindrical, and the holder 21 includes a supporting hole 23. The holder 21 supports the tool 11 inserted into the supporting hole 23. A second hammer 24 is disposed from the supporting hole 23 to the inside of the striking case 13. The second hammer 24 is movable in the direction of the axis line A1. The second hammer 24 is cylindrical, and the second hammer 24 has a large-diameter portion 25. An annular stopper 26 is provided inside the supporting hole 23, and an annular stopper 27 is provided inside the striking case 13. The large-diameter portion 25 comes into contact with the stopper 26 or the stopper 27, and accordingly, a moving range of the second hammer 24 in the direction of the axis line A1 is restricted.

A piston 28 is disposed inside the cylindrical portion 19 of the striker 17. The piston 28 is movable relative to the striker 17 in the direction of the axis line A1. Inside the cylindrical portion 19, an air damper chamber 29 is formed between the bottom portion 20 and the piston 28. An annular sealing member 30 is attached to an outer peripheral surface of the piston 28. The sealing member 30 is made of synthetic rubber, and the sealing member 30 is in contact with an inner peripheral surface of the cylindrical portion to form a sealing surface. The sealing member 30 seals the air damper chamber 29. A grip 31 is fixed to the striking case 13 with a fastening element 32. The fastening element 32 includes a bolt and a nut. The grip 31 is disposed outside the striking case 13, and an operator can grasp the grip 31.

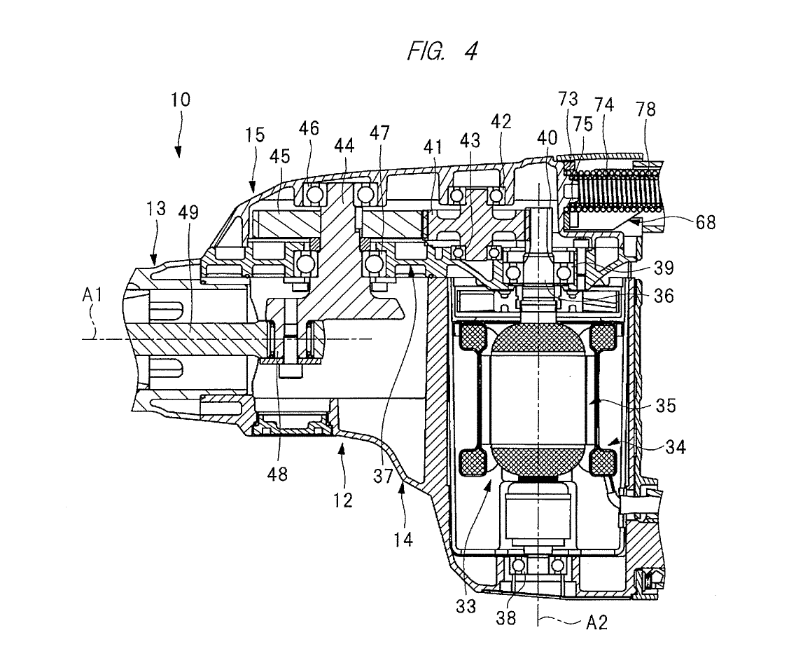

As in FIG. 1, the motor case 14 is disposed between the striking case 13 and the handle 50 in the direction of the axis line A1, and as in FIG. 4, an electric motor 33 is disposed inside the motor case 14. The electric motor 33 includes a stator 34, a rotor 35, and a rotational shaft 36. The stator 34 is disposed inside the motor case 14 and is fixed thereto, and the rotor 35 is fixed to the rotational shaft 36. The rotational shaft 36 is rotatably disposed inside the motor case 14. A partition wall 37 is provided such that an inside of the motor case 14 and an inside of the gear case 15 are partitioned. The motor case 14 supports a bearing 38, and the partition wall 37 supports a bearing 39.

The two bearings 38 and 39 support the rotational shaft 36 so as to be rotatable about an axis line A2. In a front view of the reciprocating work machine 10, the axis line A1 is orthogonal to the axis line A2. A driving gear 40 is provided on an outer peripheral surface of the rotational shaft 36. The driving gear 40 is disposed inside the gear case 15. An intermediate gear 41 is disposed inside the gear case 15. The gear case 15 supports a bearing 42, and the partition wall 37 supports a bearing 43. The two bearings 42 and 43 rotatably support the intermediate gear 41. The intermediate gear 41 meshes with the driving gear 40.

A crank shaft 44 is disposed from the inside of the gear case 15 to the inside of the motor case 14. A driven gear 45 is fixed to the crank shaft 44. The gear case 15 supports a bearing 46, and the partition wall 37 supports a bearing 47. The two bearings 46 and 47 rotatably support the crank shaft 44. The driven gear 45 meshes with the intermediate gear 41.

The crank shaft 44 includes a crank pin 48, and the crank pin 48 is at a position eccentric to the crank shaft 44 in a radial direction. A connecting rod 49 is disposed from the inside of the motor case 14 to the inside of the striking case 13, and the connecting rod 49 is coupled to the crank pin 48 and the piston 28. When the crank shaft 44 is rotated, the connecting rod 49 converts a rotational force of the crank shaft 44 into a reciprocating motion force of the piston 28.

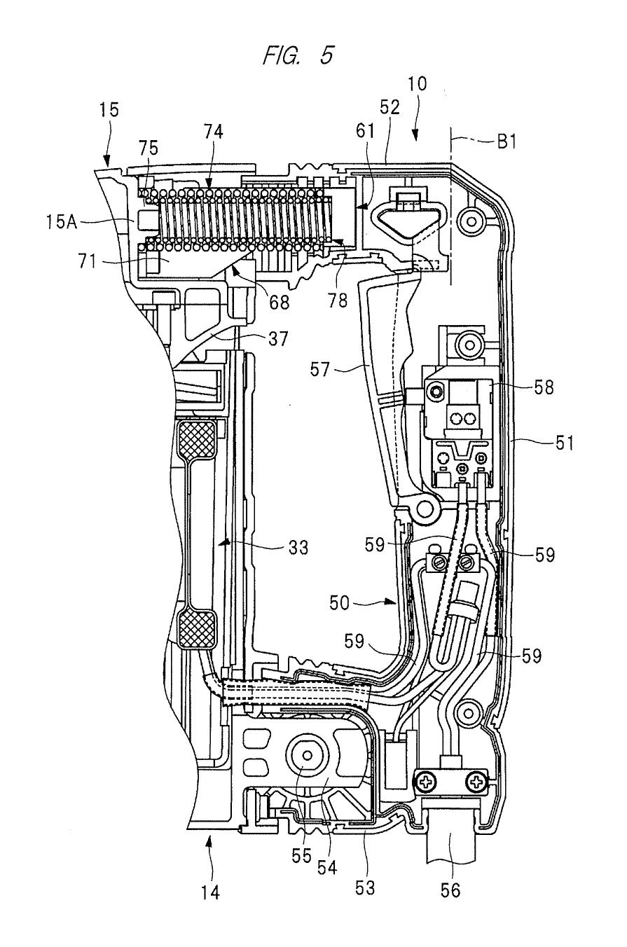

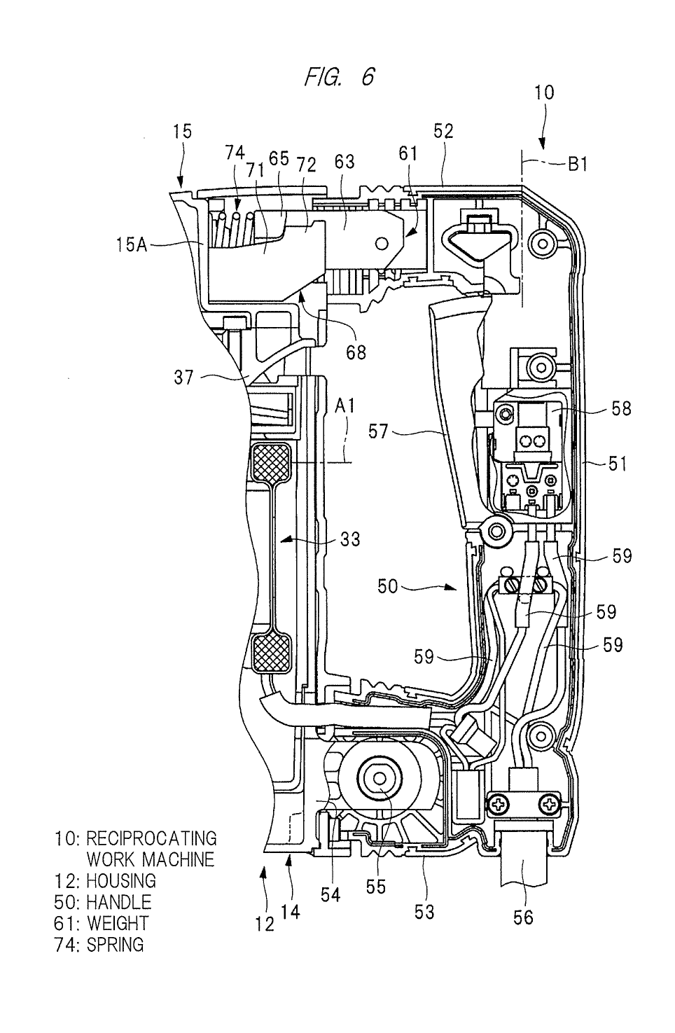

As in FIGS. 5 and 6, the handle 50 includes a cylindrical gripping portion 51, and a first end portion 52 and a second end portion 53 respectively provided at both ends of the gripping portion 51 in a direction of a center line B1. In a plan view of the reciprocating work machine 10 illustrated in FIG. 2, the handle 50 includes two constituent pieces 50A and 50B disposed across the axis line A1. The two constituent pieces 50A and 50B are fixed together with a screw member 60.

As in FIGS. 5 and 6, a mount 54 is provided to the motor case 14, and the mount 54 is exposed to the outside of the motor case 14. The second end portion 53 is connected to the mount 54 with a supporting shaft 55, and the handle 50 is rotatable within a range of predetermined angles about the supporting shaft 55. The supporting shaft 55 is fixed to the mount 54 or fixed to the second end portion 53.

To the handle 50, an end portion of a power supply code 56 is attached, and a trigger 57 and a trigger switch 58 are provided to the gripping portion 51. A lead wire 59 is provided inside the gripping portion 51 and the second end portion 53, and the lead wire 59 is connected to the trigger switch 58 and the electric motor 33. The power supply code 56 is connected to a power supply, for example, a direct-current (DC) power supply or an alternating-current (AC) power supply.

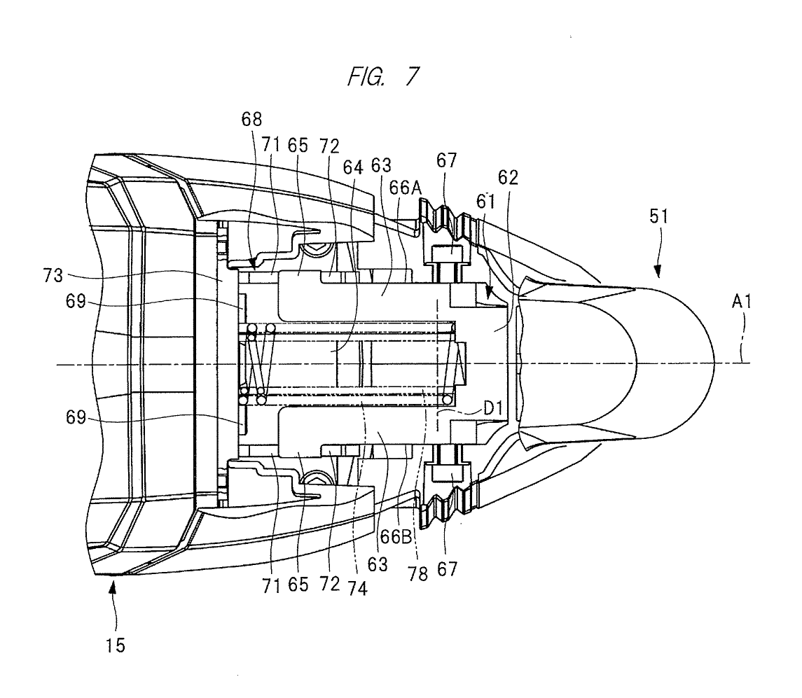

A weight 61 is provided to the first end portion 52. The weight 61 is made of a metal material. As in FIGS. 2, 7, and 8, the weight 61 includes a base portion 62, and a pair of arm portions 63 extending from the base portion 62. The pair of arm portions 63 is disposed along the direction of the axis line A1, and the pair of arm portions 63 is disposed across the axis line A1 in the plan view of the reciprocating work machine 10. Between the pair of arm portions 63, a recessed portion 64 is formed. The weight 61 has a U-shape in the plan view of the reciprocating work machine 10. Each of the pair of arm portions 63 has a protruding portion 65. The arm portions 63 respectively have an outer surface 66A and an outer surface 66B. As in FIG. 7, the outer surfaces 66A and 66B are disposed at an interval in a direction of a center line D1 of the supporting shaft 55. The protruding portion 65 protrudes from the outer surfaces 66A and 66B in a direction orthogonal to the axis line A1. The weight 61 is fixed to the first end portion 52 with a screw member 67.

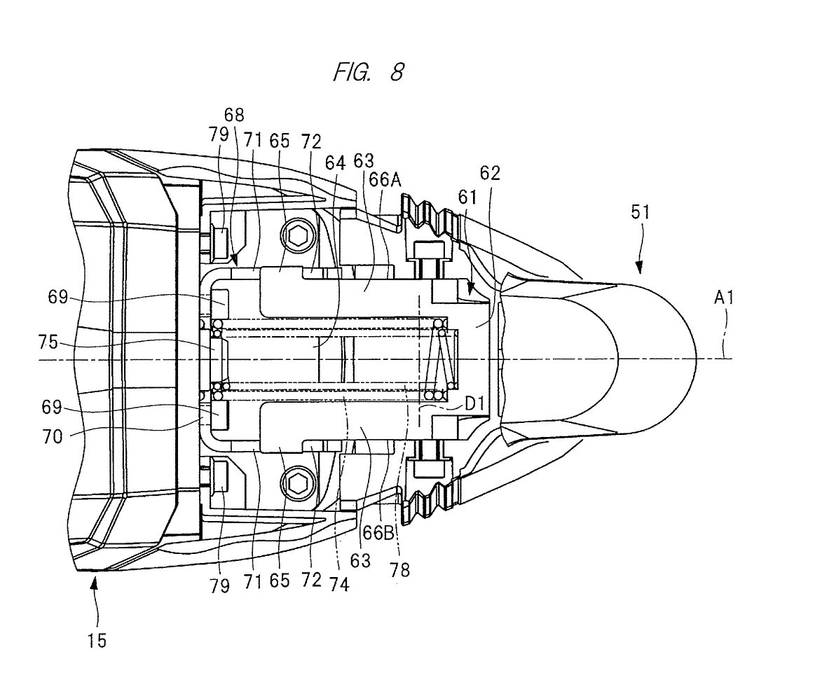

A guide portion 68 is provided to the gear case 15. The guide portion 68 is fixed to the gear case 15 with a screw member 69. The guide portion 68 is made of a metal material. The guide portion 68 has a base portion 70, and a pair of leg portions 71 continuous to the base portion 70. The pair of leg portions 71 is disposed along the direction of the axis line A1. In the plan view of the reciprocating work machine 10, the pair of leg portions 71 is disposed across the axis line A1 and parallel to each other as in FIG. 8. The base portion 70 comes in contact with the gear case 15, and the pair of leg portions 71 protrudes from the base portion 70 toward the first end portion 52.

In the plan view of the reciprocating work machine 10, the weight 61 is disposed between the pair of leg portions 71 in the direction orthogonal to the axis line A1. An arrangement region of the protruding portion 65 overlaps with an arrangement region of the pair of leg portions 71. There is provided an engagement portion 72 protruding from the pair of leg portions 71. A direction in which the engagement portion 72 protrudes from the pair of leg portions 71 is an opposite direction of a part where the electric motor 33 is disposed. The protruding portion 65 is disposed between the engagement portion 72 and the base portion 70 in the direction of the axis line A1. When the handle 50 rotates clockwise about the supporting shaft 55 in FIG. 6, the protruding portion 65 comes in contact with the engagement portion 72, and a range of rotation of the handle 50 is restricted.

As in FIG. 7, a damper 73 is provided to the gear case 15. The damper 73 is made of synthetic rubber, and the damper 73 is fixed to the gear case 15 with a screw member 79. When the handle 50 turns counterclockwise about the supporting shaft 55 in FIGS. 5 and 6, a tip end of the pair of arm portions 63 abuts on the damper 73, and the damper 73 restricts an angle range in which the handle 50 rotates about the supporting shaft 55.

Springs 74 and 78 are disposed between the gear case 15 and the first end portion 52. The springs 74 and 78 are metal coil springs that generate a repulsive force by receiving a compressive load. A spring constant of the spring 74 is larger than a spring constant of the spring 78. An outer diameter of the spring 78 is smaller than an inner diameter of the spring 74, and the spring 78 is disposed inside the spring 74. The gear case 15 has a supporting portion 75. The supporting portion 75 protrudes from a wall 15A of the gear case 15. The springs 74 and 78 are disposed in the recessed portion 64 and are supported by the supporting portion 75. That is, the weight 61 supports an end portion of each of the springs 74 and 78 in an expansion and contraction direction. The springs 74 and 78 are sandwiched by the gear case 15 and the base portion 62, and the springs 74 and 78 constantly receive the compressive load in the direction of the axis line A1.

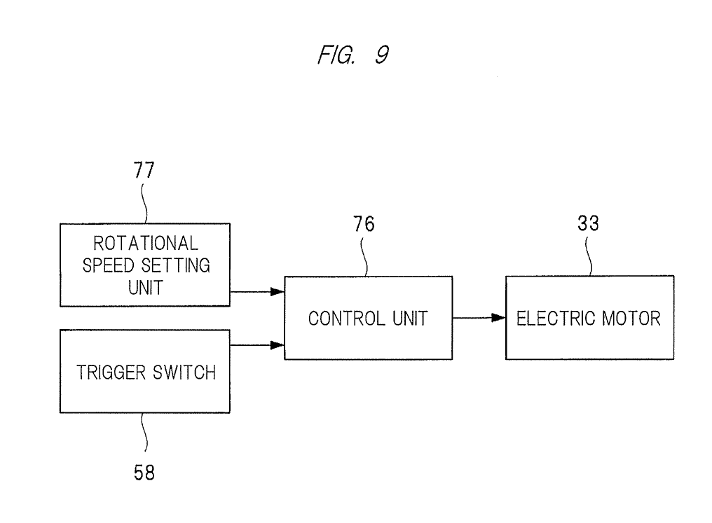

The reciprocating work machine 10 includes a control unit 76 illustrated in FIG. 9. The control unit 76 is provided inside the handle 50 or the motor case 14. The control unit 76 includes a microcomputer having an input port and an output port, and a storage unit and an arithmetic unit connected to the microcomputer. In addition, the reciprocating work machine 10 includes a rotational speed setting unit 77. The rotational speed setting unit 77 includes a lever, a switch, a panel, and the like provided to the housing 12. A signal output from the trigger switch 58 and a signal output from the rotational speed setting unit 77 are input to the control unit 76. An operator operates the rotational speed setting unit 77, so that a target rotational speed of the electric motor 33 can be set. The target rotational speed can be set in a stepwise manner or in a stepless manner. The control unit 76 rotates the electric motor 33 when the trigger switch 58 is turned on and stops the electric motor 33 when the trigger switch 58 is turned off. The control unit 76 performs control to bring an actual rotational speed of the electric motor 33 closer to the target rotational speed.

A material, a mass, and a specific gravity of an element constituting the reciprocating work machine 10 may be as follows, for example. The striking case 13, the motor case 14, and the gear case 15 constituting the housing 12 are each made of a metal material such as a casting aluminum alloy. Further, the holder 21 is made of a metal material such as a material harder than the casting aluminum alloy. Each specific gravity of the casting aluminum alloy constituting the housing 12 and the material constituting the holder 21 is 2.68 [g/ĉ3].

The handle 50 is made of a synthetic resin such as a polyamide resin. The polyamide resin includes nylon (trade name of INVISTA K.K.). A specific example of the handle 50 is as follows. Each of the constituent pieces 50A and 50B is 200 g in mass, and the handle 50 is 400 g in mass. A specific gravity of the polyamide resin constituting the handle 50 is 1.2 [g/ĉ3].

As the metal material constituting the weight 61, common steel or carbon steel for machine structural use, for example, is used. The weight 61 is 250 g in mass. A specific gravity of the metal material constituting the weight 61 is 7.86 [g/cm̂3].

As the metal material constituting the guide portion 68, special steel, alloy steel for machine structural use, or tool steel, for example, is used. The guide portion 68 may be 66 g in mass. A specific gravity of the metal material constituting the guide portion 68 is 7.85 [g/cm̂3].

An example of use of the reciprocating work machine 10 will be described. The operator, for example, grips the grip 31 with the left hand, grips the gripping portion 51 of the handle 50 with the right hand, and presses the tool 11 against an object. Then, the large-diameter portion 25 comes in contact with the stopper 27, and the second hammer 24 stops. Then, when the operator operates the trigger 57 to turn the trigger switch 58 on, the control unit 76 supplies the electric motor 33 with electric power, and the rotational shaft 36 is rotated. The control unit 76 controls an actual rotational speed of the rotational shaft 36 based on the target rotational speed set by the rotational speed setting unit 77.

A rotational force of the rotational shaft 36 is transmitted to the crank shaft 44 through the intermediate gear 41 and the driven gear 45, and the crank shaft 44 is rotated. When the crank shaft 44 rotates, the piston 28 reciprocates in the direction of the axis line A1, and the striker 17 strikes the second hammer 24. The piston 28 and the striker 17 constitute a striking mechanism that reciprocates by power of the electric motor 33. A striking force received by the second hammer 24 is transmitted to the tool 11, and the object is crushed. When the trigger 57 is operated to turn the trigger switch 58 off, the control unit 76 stops the electric motor 33.

During striking operation, the piston 28 and the connecting rod 49 operate in the direction of the axis line A1 while a reaction force of the striking force applied to the tool 11 is transmitted to the connecting rod 49 through the striker 17 and the piston 28, and its load is transmitted to the housing 12 through the crank shaft 44 and the bearings 46 and 47. When the housing 12 vibrates in the direction of the axis line A1, the handle 50 rotates about the supporting shaft 55 relative to the housing 12, and the springs 74 and 78 expand and contract. The springs 74 and 78 reduce vibration transmitted from the housing 12 to the handle 50. Thus, workability in using the reciprocating work machine 10 improves.

Furthermore, when the handle 50 rotates about the supporting shaft 55 relative to the housing 12, the pair of leg portions 71 slides on the outer surfaces 66A and 66B of the pair of arm portions 63. That is, the weight 61 partially reduces a part of kinetic energy transmitted from the housing 12 to the handle 50 by frictional resistance to suppress vibration of the handle 50. Furthermore, the guide portion 68 and the weight 61 restrict moving of the handle 50 in the direction of the center line D1 relative to the housing 12 and function as guides when the handle 50 moves in the direction of the axis line A1.

Further, the weight 61 is attached to the handle 50, and a natural frequency of the handle 50 to which the weight 61 is fixed is smaller than a natural frequency of the handle 50 alone. Thus, it is possible to further reduce the vibration transmitted from the housing 12 to the handle 50.

Further, the weight 61 and the springs 74 and 78 have arrangement regions in the direction of the axis line A1 that are overlapped with each other, arrangement regions in the direction of the center line D1 that are overlapped with each other, and arrangement regions in the direction of the center line B1 that are overlapped with each other. Thus, it is not necessary to provide a dedicated arrangement space for the weight 61, and it is possible to suppress an increase in size of the reciprocating work machine 10.

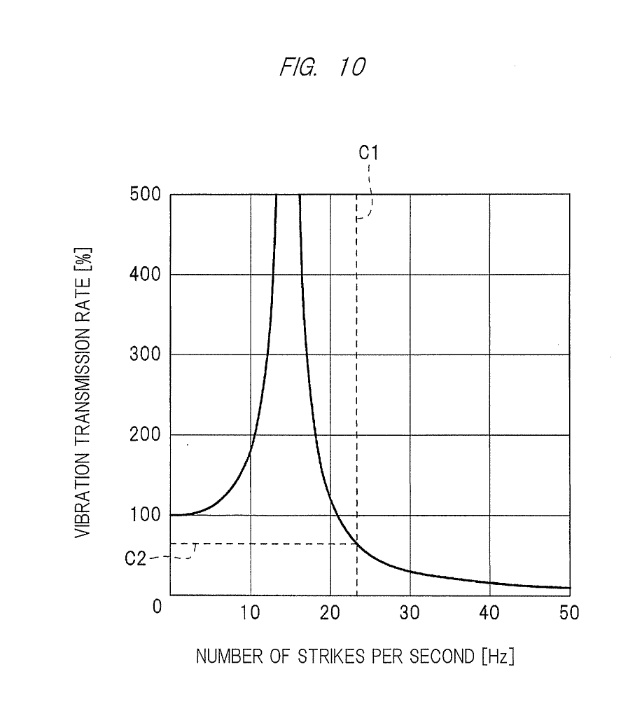

FIG. 10 illustrates characteristics of the reciprocating work machine 10 according to the embodiment. A horizontal axis indicates the number of strikes per second [Hz], and a vertical axis indicates a vibration transmission rate [%]. The vibration transmission rate is a rate at which vibration in a striking axis direction of the housing 12 is transmitted to the handle 50. The striking axis direction refers to the direction of the axis line A1. The vibration transmission rate of 100% means that a vibration amplitude of the housing 12 and a vibration amplitude of the handle 50 are the same. The vibration transmission rate of less than 100% means that the vibration amplitude of the handle 50 is smaller than the vibration amplitude of the housing 12. The vibration transmission rate exceeding 100% means that the vibration amplitude of the handle 50 is larger than the vibration amplitude of the housing 12 due to resonance or the like. A straight line C1 indicates the number of strikes corresponding to a maximum rotational speed of the electric motor 33. The maximum rotational speed of the electric motor 33 is a maximum value of the target rotational speed set by the rotational speed setting unit 77. A straight line C2 indicates the vibration transmission rate corresponding to the maximum rotational speed of the electric motor 33.

In the reciprocating work machine 10 according to the embodiment, the weight 61 is made of a steel material of 250 g in mass, and when the number of strikes per second corresponding to the maximum rotational speed of the electric motor 33 is 23.3 times, the vibration transmission rate is less than 68%.

In the reciprocating work machine 10 according to the embodiment, the number of strikes per second corresponding to the maximum rotational speed of the electric motor 33 can be set to 15.7 to 27.5 times, 16.6 times, 16.7 to 36.6 times, 20 to 41.7 times, 23.3 times, 30 times, 50 times, and the like according to each use or size. As the maximum rotational speed of the electric motor 33 increases, the number of strikes per second increases.

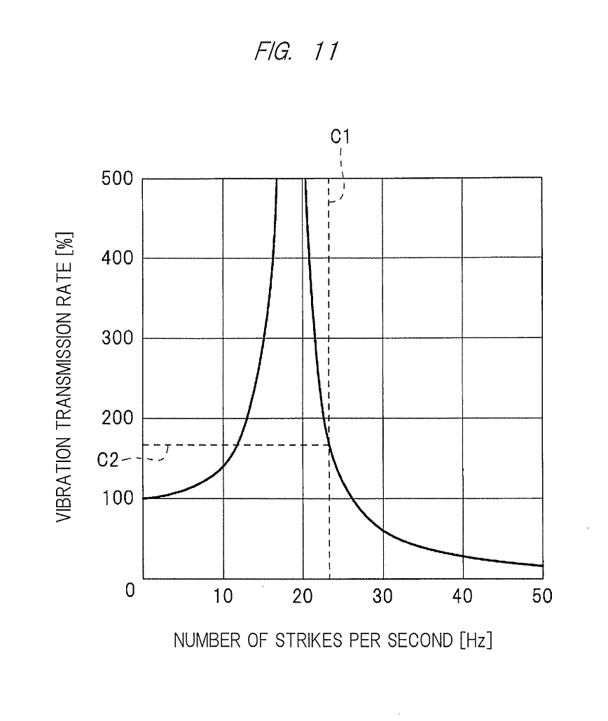

FIG. 11 illustrates characteristics of a reciprocating work machine according to a first comparative example. In the reciprocating work machine according to the first comparative example, a weight is made of an aluminum material of 87 g in mass, and when the number of strikes per second corresponding to the maximum rotational speed of an electric motor is 23.3 times, the vibration transmission rate is 171%.

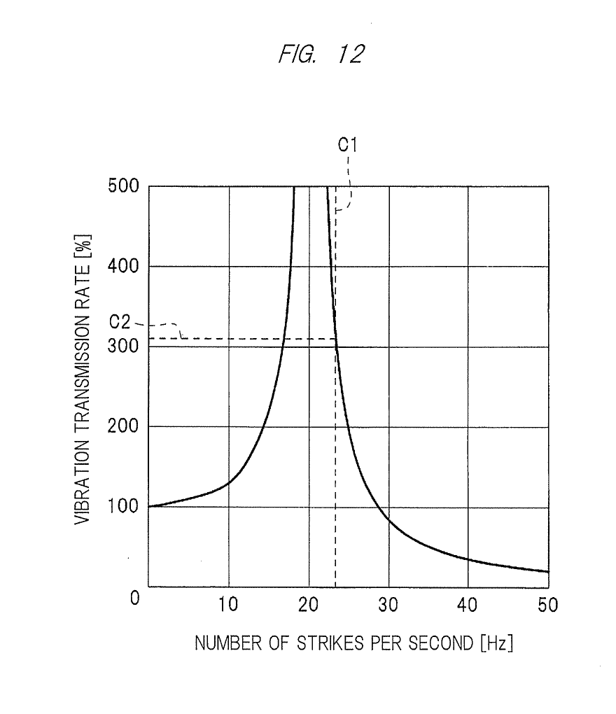

FIG. 12 illustrates characteristics of a reciprocating work machine according to a second comparative example. In the reciprocating work machine according to the second comparative example, a weight is made of a resin material of 39 g in mass, and when the number of strikes per second corresponding to the maximum rotational speed of an electric motor is 23.3 times, the vibration transmission rate is 300%.

Note that the vibration transmission rate of the reciprocating work machine according to the second comparative example without a weight is 100% or more. It is apparent that the vibration transmission rate of the reciprocating work machine 10 according to the embodiment is smaller than the vibration transmission rate of the reciprocating work machine according to the second comparative example without a weight.

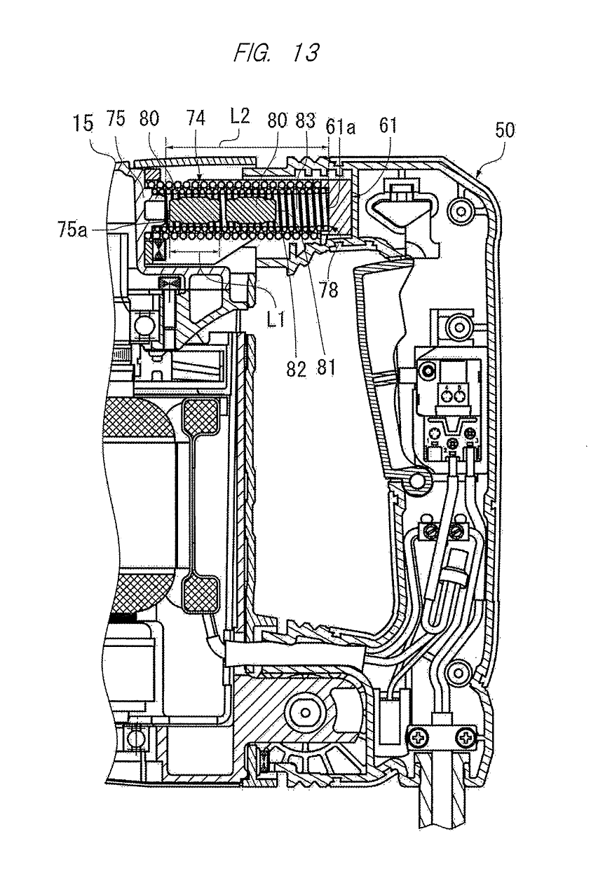

FIGS. 13 to 17 are views illustrating another example of the handle and the vibration reduction mechanism of the reciprocating work machine. This example is different from the embodiment illustrated in FIGS. 1 to 8 in that a damper 80 is provided.

When vibration from the housing 12, a load of pressing the handle 50 against a side of the housing 12, and the like are transmitted to the springs 74 and 78, the springs 74 and 78 come into contact with each other while expanding and contracting and cause friction with the supporting portion 75 and the weight 61, and as a result, an abnormal noise may be generated. In particular, since the spring 78 has a spring constant smaller than that of the spring 74, vibration that causes the abnormal noise is likely to be sustained by being coincident with the natural frequency of the spring 78. In addition, since the spring 78 is not provided with a member for damping vibration such as the damper 73 which comes in contact with the spring 74, on a sandwiching surface thereof, the vibration that causes the abnormal noise is hardly damped. Accordingly, the spring 78 may continue to make the abnormal noise for a long period of time after completion of work and after pressing operation of the handle 50, and when an operator hears this abnormal noise, the noise may be offensive to his/her ears, and there might be a possibility of causing misunderstanding of any failure. Thus, the abnormal noise is not preferred.

Two dampers 80 are accommodated inside the spring 78, which is a cylindrical coil spring. An internal space 83 is formed by an inner peripheral surface of the spring 78, a rear end surface 75a in a range of being located inside in a radial direction of the spring 78 at the supporting portion 75, and a front end surface 61a in a range of being located inside in the radial direction of the spring 78 at the weight 61, and the dampers 80 are accommodated inside this internal space 83.

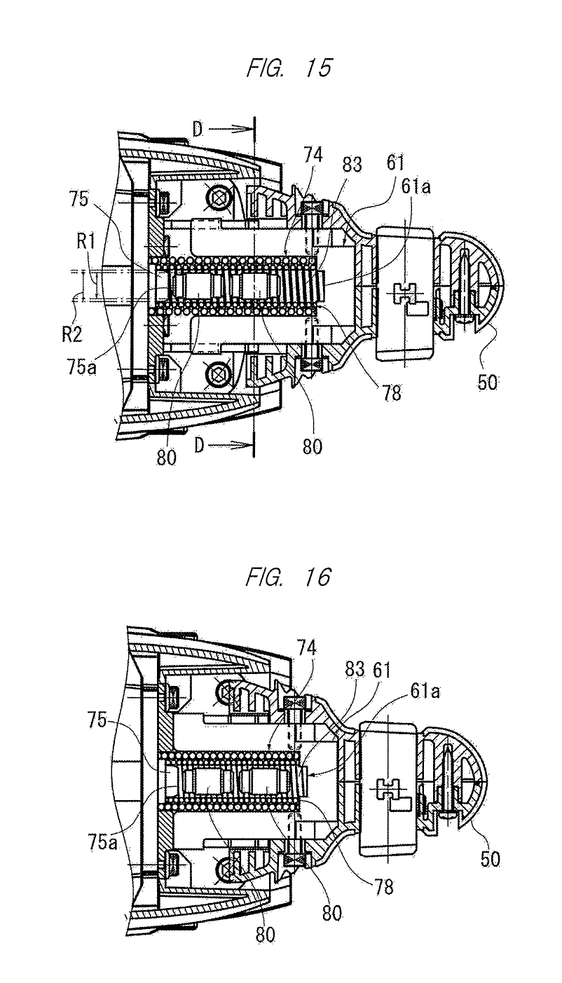

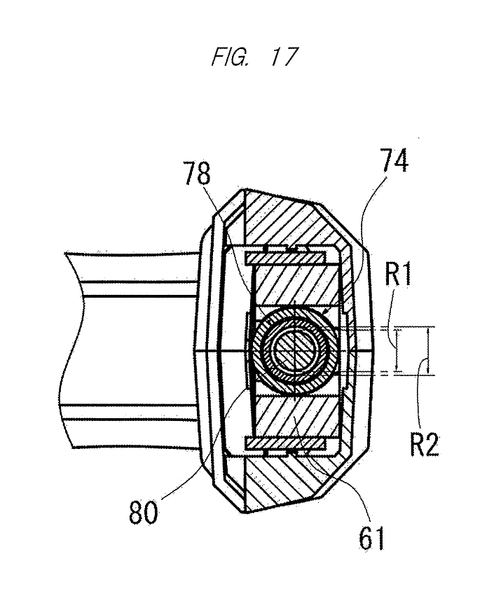

Each of the dampers 80 has a substantially cylindrical shape, and an end surface 81 on either side has a chamfered portion 82 where an edge portion is chamfered. FIG. 17 illustrates a cross-sectional view of the vibration reduction mechanism taken along the D-D surface of FIG. 15. An outer diameter R1 of the damper 80 is smaller than an inner diameter R2 of the spring 78. Accordingly, the damper 80 is provided so as to be freely movable (floatable) in all directions inside the spring 78, and contact with an inner surface of the spring 78 and free-floating inside the spring 78 are repeated. When the damper 80 contacts the inner surface of the spring 78, the vibration that causes the abnormal noise of the spring 80 is damped by the damper 80, and the vibration is stopped. Accordingly, it is possible to stop the abnormal noise in a short time as well as to suppress occurrence of the abnormal noise.

Since the damper 80 is configured so as to be accommodated inside the spring 78, a structure in which the damper 80 and the spring 78 come in contact with each other can be easily achieved without making any special devise to the shape of the damper 80. Since the damper 80 is configured so as to have the outer diameter smaller than the inner diameter of the spring 78 and to be freely movable inside the spring 78, the damper 80 is prevented from closely adhering to the spring 78 and hindering expansion and contraction of the spring 78. Since the damper 80 is configured so as to have the shape in which the edge portion of the end surface on either side of the cylinder is chamfered, it is possible to prevent the damper 80 from being caught by the spring 78 upon expansion and contraction and hindering the expansion and contraction as well as to prevent the damper 80 from wearing early. Note that, in addition to the above-described configuration, it is also possible to suppress the occurrence of the abnormal noise even in another structure allowing the damper 80 to come into contact with the spring 78, for example, in a structure in which the damper 80 is provided between the spring 78 and the spring 74 and is formed into a cylindrical shape covering an outer periphery of the spring 78.

As a mass of the damper 80 is increased and a load at which the dampers 80 come in contact with the spring 78 is increased, an effect of suppressing the vibration of the spring 78 by the damper 80 is increased. Meanwhile, in a case where the outer diameter of the damper 80 is increased in order to increase the mass of the dampers 80, an inner periphery of the spring 78 slides on an outer periphery of the dampers 80, which may hinder the expansion and contraction of the spring 78. Further, in a case where a length L in an axial direction of the damper 80 is increased, the spring 78 may come in contact with the damper 80 when it is bent while expanding and contracting, which may hinder the expansion and contraction thereof. In the configurations illustrated in FIGS. 13 to 17, the plurality of dampers 80 are provided, and accordingly, it is possible to increase the total mass of the dampers 80 without increasing the outer diameter or the length in the axial direction of the damper 80. Accordingly, it is possible to increase the total mass of the dampers 80 while making the dampers 80 less likely to interfere with bending and operation of expansion and contraction of the spring 78.

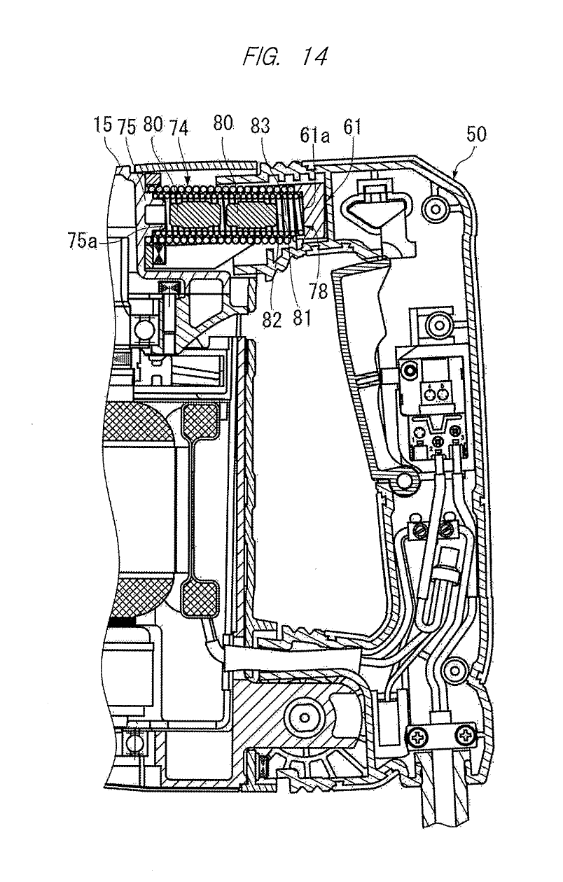

FIGS. 14 and 16 illustrate a state in which, by the handle 50 moving closer to the housing 12 and by the springs 74 and 78 being compressed, the supporting portion 75 provided to the gear case 15 of the housing 12 is brought the closest to the weight 61 provided to the handle 50. In this state, a length in the axial direction of the damper 80 is denoted by L1, and a distance between a rear end surface 74a of the supporting portion 75 and a front end surface 61a of the weight 61 is denoted by L2. Here, since it is configured such that the length L1 is smaller than the distance L2, the damper 80 does not come in contact simultaneously with both of the supporting portion 75 and the weight 61 and is not sandwiched thereby, and prevention of a function of the spring 78 of reducing the vibration transmitted from the housing 12 to the handle 50 is suppressed. Note that it is desirable that the length L1 in the axial direction of the single damper 80 is shorter than the distance L2 when the supporting portion 75 is brought the closest to the weight 61 as a matter of course, and when a total of the lengths L1 in the axial direction of all of the dampers 80 provided inside the spring 78 is also shorter than the distance L2 when the supporting portion 75 is brought the closest to the weight 61, it is possible to obtain an effect of the spring 78 of much more effectively reducing the vibration of the handle 50.

Note that, in order to achieve an effect of effectively suppressing the vibration of the spring 78, an effect of preventing the spring 80 from wearing due to contact between the damper 80 and the spring 80 by forming the damper 80 of a material having lower hardness than that of the spring 78, and an effect of suppressing generation of the abnormal noise when the damper 80 and the spring 78 come in contact with each other, it is most appropriate that the damper 80 is made of an elastic body such as rubber. However, by forming the damper 80 of a resin and the like having lower hardness than that of the spring 78 other than rubber, it is possible to achieve suppression of the abnormal noise and prevention of wearing of the spring 78.

The electric motor 33 described in the embodiment corresponds to the motor, the piston 28 and the striker 17 correspond to the striking mechanism, the springs 74 and 78 correspond to the elastic body, the outer surface 66A corresponds to a first side surface, the outer surface 66B corresponds to a second side surface, the damper 80 corresponds to a resin member, the supporting portion 75 corresponds to a spring supporting portion, the direction of the axis line A1 corresponds to the reciprocating direction, and the direction of the center line B1 corresponds to a predetermined direction. The direction of the center line B1 crosses the direction of the axis line A1.

The reciprocating work machine is not to be limited to the embodiment, and various modifications are possible within the range not deviating from the gist thereof. For example, a metal spring used as the elastic body may also be not only a coil spring, but also a torsion spring and a leaf spring. As the elastic body, it is also possible to use synthetic rubber in place of the metal spring. The power supply that supplies the electric motor with electric power includes an AC power supply and a DC power supply. The DC power supply includes a battery attached to and detached from the handle.

A conversion mechanism for converting a rotational force of the motor into a reciprocating force of the piston includes not only a crank mechanism, but also a cam mechanism. The motor includes not only an electric motor, but also a hydraulic motor, a pneumatic motor, and an internal combustion engine. A resin constituting the handle may also be not only the polyamide resin, but also a urethane resin and a polyethylene resin. The housing is a hollow container accommodating the striking mechanism, and it does not matter whether the inside is hermetically sealed or not.

When the handle of the reciprocating work machine is operable relative to the housing, it means that the handle is relatively movable. Accordingly, the reciprocating work machine may be the one with the handle rotatable about the supporting shaft relative to the housing or the one with the handle slidable via a rail member relative to the housing. In this case, the handle slides in the reciprocating direction of the striking mechanism relative to the housing.

### EXPLANATION OF REFERENCE CHARACTERS

10 . . . reciprocating work machine, 11 . . . tool, 12 . . . housing, 13 . . . striking case, 14 . . . motor case, 15 . . . gear case, 15A . . . wall, 16, 22, 60, 67, 69, 79 . . . screw member, 17 . . . striker, 18 . . . guide portion, 19 . . . cylindrical portion, 20 . . . bottom portion, 21 . . . holder, 23 . . . supporting hole, 24 . . . second hammer, 25 . . . large-diameter portion, 26, 27 . . . stopper, 28 . . . piston, 29 . . . air damper chamber, 30 . . . sealing member, 31 . . . grip, 32 . . . fastening element, 33 . . . electric motor, 34 . . . stator, 35 . . . rotor, 36 . . . rotational shaft, 37 . . . partition wall, 38, 39, 42, 43, 46, 47 . . . bearing, 40 . . . driving gear, 41 . . . intermediate gear, 44 . . . crank shaft, 45 . . . driven gear, 48 . . . crank pin, 49 . . . connecting rod, 50 . . . handle, 50A, 50B . . . constituent piece, 51 . . . gripping portion, 52 . . . first end portion, 53 . . . second end portion, 54 . . . mount, 55 . . . supporting shaft, 56 . . . power supply code, 57 . . . trigger, 58 . . . trigger switch, 59 . . . lead wire, 61 . . . weight, 61a . . . front end surface, 62, 70 . . . base portion, 63 . . . arm portion, 64 . . . recessed portion, 65 . . . protruding portion, 66A, 66B . . . outer surface, 68 . . . guide portion, 71 . . . leg portion, 72 . . . engagement portion, 73 . . . damper, 74, 78 . . . spring, 75 . . . supporting portion, 75a . . . rear end surface, 76 . . . control unit, 77 . . . rotational speed setting unit, 80 . . . damper, 81 . . . end surface, 82 . . . chamfered portion, 83 . . . internal space, A1, A2 . . . axis line, B1, D1 . . . center line, C1, C2 . . . straight line.

1. A reciprocating work machine provided with a motor, a striking mechanism reciprocating by power of the motor and striking a tool, and a housing accommodating the motor and the striking mechanism, the reciprocating work machine comprising:
a resin handle operably connected to the housing;
an elastic body provided between the housing and the handle and expanding and contracting in a reciprocating direction of the striking mechanism when the handle is operated relative to the housing; and
a weight provided to the handle and made of a material having a specific gravity higher than each of a specific gravity of a material constituting the handle and a specific gravity of a material constituting the housing.

2. The reciprocating work machine according to claim 1,
wherein a supporting shaft disposed along a direction orthogonal to the reciprocating direction is provided, and
the handle is connected to the housing so as to be rotatable about the supporting shaft.

3. The reciprocating work machine according to claim 2,
wherein the handle includes a gripping portion disposed along the direction orthogonal to the reciprocating direction,
the gripping portion has a first end portion and a second end portion disposed at both ends in a predetermined direction crossing the reciprocating direction,
the elastic body is disposed between the first end portion and the housing,
the supporting shaft connects the second end portion to the housing, and
the weight is provided to the first end portion.

4. The reciprocating work machine according to claim 3,
wherein the elastic body is a spring supported by the housing and the handle, and
the weight is fixed to the handle and supports an end portion of the spring in an expansion and contraction direction.

5. The reciprocating work machine according to claim 1,
wherein a mass of the weight is set such that a vibration transmission rate in the reciprocating direction transmitted from the housing to the handle when the motor rotates at a maximum rotational number and when the handle is provided with the weight is smaller than a vibration transmission rate in the reciprocating direction transmitted from the housing to the handle when the motor rotates at the maximum rotational number and when the handle is not provided with the weight.

6. The reciprocating work machine according to claim 5,
wherein the vibration transmission rate when the handle is not provided with the weight is equal to or greater than 100%, and
the vibration transmission rate when the handle is provided with the weight is less than 100%.

7. The reciprocating work machine according to claim 1,
wherein the elastic body is a spring sandwiched by the housing and the handle, and
the weight is fixed to the handle and supports an end portion of the spring in an expansion and contraction direction.

8. The reciprocating work machine according to claim 7,
wherein a supporting shaft orthogonal to the reciprocating direction of the striking mechanism is provided,
the handle is connected to the housing so as to be rotatable about the supporting shaft,
the weight has a first side surface and a second side surface disposed at an interval in a direction of a center line of the supporting shaft,
the housing includes a guide portion,
the guide portion has a pair of leg portions disposed along the reciprocating direction, and
the pair of leg portions slides on the first side surface and the second side surface when the handle rotates about the supporting shaft.

9. The reciprocating work machine according to claim 7,
wherein the weight has a recessed portion, and
the spring is disposed in the recessed portion.

10. The reciprocating work machine according to claim 7,
wherein the weight restricts a range of operation of the handle relative to the housing by abutting on the housing.

11. The reciprocating work machine according to claim 7, comprising:
a resin member coming in contact with the spring.

12. The reciprocating work machine according to claim 11,
wherein the spring is a cylindrical coil spring, and
the resin member is accommodated inside the spring.

13. The reciprocating work machine according to claim 12,
wherein the resin member is formed to be smaller than an inner diameter of the spring and is floatable inside the spring.

14. (canceled)

15. The reciprocating work machine according to claim 13,
wherein the resin member is made of rubber and has a substantially cylindrical shape in which an edge portion of an end surface on either side of a cylinder is chamfered,
an outer diameter of the resin member is smaller than the inner diameter of the spring, and
a length of the resin member in an axial direction is shorter than a distance when a spring supporting portion provided to the housing and the weight are the closest to each other.

16. The reciprocating work machine according to claim 11, comprising:
a plurality of the resin members arranged in the expansion and contraction direction of the spring.
